(19) United States
(12) Patent Application Publication
(10) Pub. No.: US 2023/0153757 A1
(43) Pub. Date: May 18, 2023

(54) System and Method for Rapid Informatics-Based Prognosis and Treatment Development

(71) Applicant: Atropos LLC, New York, NY (US)

(72) Inventors: Saurabh Gombar, San Diego, CA (US); Nigam Shah, Menlo Park, CA (US); Yen Sia Low, San Francisco, CA (US); Vlad Polony, Novato, CA (US); Uday Reddy, San Mateo, CA (US)

(73) Assignee: Atropos LLC, New York, NY (US)

(21) Appl. No.: 18/056,028

(22) Filed: Nov. 16, 2022

Related U.S. Application Data
(60) Provisional application No. 63/279,802, filed on Nov. 16, 2021.

(51) Int. Cl. G06Q 10/10; G06Q 10/04

(52) U.S. Cl. CPC G06Q 10/10; G06Q 10/04

(57) ABSTRACT

In certain aspects of the present disclosure, a method for rapid informatics-based prognosis development includes receiving a consult request. The method includes selecting a study template configured to design a study to develop a consult output in response to the consult request. The method includes receiving a completed study template, including a completed field in the study template based on information from the consult request, the completed field comprising a variable provided in at least one of a timeframe field, a phenotype field, a cohort field, and a demographic field. The method includes obtaining cohort data based on the completed study template, the cohort data derived from a plurality of patient objects. The method includes generating the consult output based on the cohort data, the consult output comprising a result from an analysis of the cohort data according to a criteria and an instruction in the study template.

### CROSS-REFERENCE TO RELATED APPLICATION

This application claims priority to U.S. Provisional Patent Application No. 63/279,802, titled “System and Method for Rapid Informatics-Based Prognosis and Treatment Development,” filed on Nov. 16, 2021, which is expressly incorporated by reference herein in its entirety.

### BACKGROUND OF INVENTION

There is often not enough time and resources to make medical decisions based on rigorous evidence from a randomized trial study or a comprehensive survey of data from existing studies. Retrospective observational studies using the electronic health record (EHR) can generate evidence from real patient populations relevant to a given consult request (i.e., an informatics consult). However, designing and performing retrospective observational studies remain a time consuming, manual process involving multiple steps, such as data extraction from multiple sources, phenotyping, characterizing a patient's relevant clinical characteristics, and then performing the relevant analysis based on the a suitable and comprehensive cohort of past patients, all of which is made more complicated when dealing with multiple data sources with differing standards and formats (e.g., classifications, hierarchies, terminology).

The ability to generate and represent a patient's medical history in a patient timeline object is helpful to ingesting data from multiple sources and characterizing relevant clinical characteristics of a patient from historical data. However, the remaining steps of phenotyping and analysis remain time consuming and largely manual, typically taking several weeks, if not more, to provide a rigorous, evidence-based prognosis and treatment recommendation.

Thus, it is desirable to have a system and method for rapid informatics-based prognosis and treatment development.

### SUMMARY

According to certain aspects of the present disclosure, a method for rapid informatics-based prognosis development is provided. The method includes receiving a consult request. The method includes selecting a study template configured to design a study to develop a consult output in response to the consult request. The method includes receiving a completed study template, including a completed field in the study template based on information from the consult request, the completed field comprising a variable provided in at least one of a timeframe field, a phenotype field, a cohort field, and a demographic field. The method includes obtaining cohort data based on the completed study template, the cohort data derived from a plurality of patient objects. The method includes generating the consult output based on the cohort data, the consult output comprising a result from an analysis of the cohort data according to a criteria and an instruction in the study template.

According to certain aspects of the present disclosure, a system for rapid informatics-based prognosis development is provided. The system includes a memory comprising instructions and a processor configured to execute the instructions which, when executed cause the processor to receive a consult request. The processor is configured to execute the instructions which, when executed, cause the processor to select a study template configured to design a study to develop a consult output in response to the consult request. The processor is configured to execute the instructions which, when executed, cause the processor to receive a completed study template, including a completed field in the study template based on information from the consult request, the completed field comprising a variable provided in at least one of a timeframe field, a phenotype field, a cohort field, and a demographic field. The processor is configured to execute the instructions which, when executed, cause the processor to obtain cohort data based on the completed study template, the cohort data derived from a plurality of patient objects. The processor is configured to execute the instructions which, when executed, cause the processor to generate the consult output based on the cohort data, the consult output comprising a result from an analysis of the cohort data according to a criteria and an instruction in the study template.

According to certain aspects of the present disclosure, a non-transitory machine-readable storage medium comprising machine-readable instructions for causing a processor to execute a method for rapid informatics-based prognosis development is provided. The method includes receiving a consult request. The method includes selecting a study template configured to design a study to develop a consult output in response to the consult request. The method includes receiving a completed study template, including a completed field in the study template based on information from the consult request, the completed field comprising a variable provided in at least one of a timeframe field, a phenotype field, a cohort field, and a demographic field. The method includes obtaining cohort data based on the completed study template, the cohort data derived from a plurality of patient objects. The method includes generating the consult output based on the cohort data, the consult output comprising a result from an analysis of the cohort data according to a criteria and an instruction in the study template.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a simplified block diagram of an exemplary system for rapid informatics-based prognosis development using an advanced cohort engine, in accordance with one or more embodiments.

FIG. 2A is a simplified block diagram of an exemplary computing system configured to implement the exemplary system in FIG. 1 and to perform steps of the method illustrated in FIG. 4, in accordance with one or more embodiments;

FIG. 2B is a simplified block diagram of an exemplary distributed computing system implemented by a plurality of exemplary computing devices, in accordance with one or more embodiments;

FIG. 3 is a simplified block diagram of an exemplary user interface for a study template for input to an analytics engine in a rapid informatics-based prognosis development system, in accordance with one or more embodiments;

FIG. 4 is a flow diagram illustrating an exemplary method for rapid informatics-based prognosis development, in accordance with one or more embodiments; and

FIG. 5 is a simplified block diagram of exemplary elements of a report generated by a rapid informatics-based prognosis development system, in accordance with one or more embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for leveraging online audio for sales engagement.

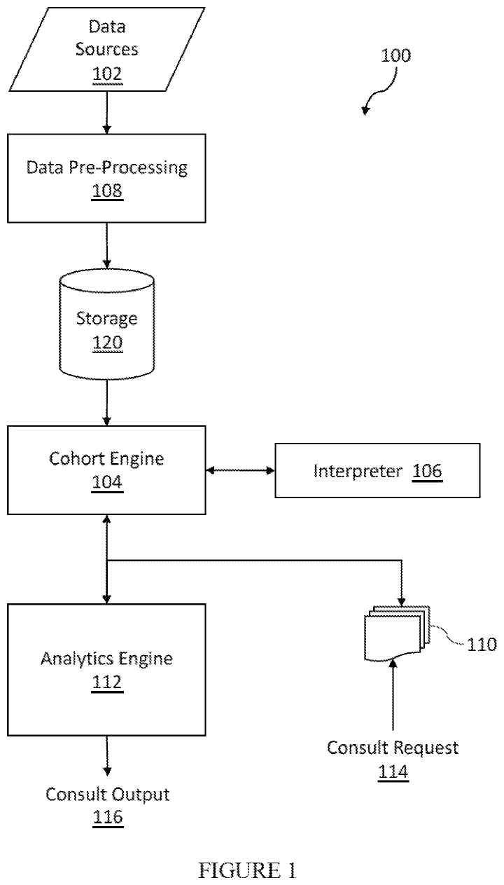

FIG. 1 is a simplified block diagram of an exemplary system for rapid informatics-based prognosis development, in accordance with one or more embodiments. System 100 includes a cohort engine 104, an interpreter 106, a data pre-processing module 108, templates 110, analytics engine 112 and storage 120. Cohort engine 104 may be configured to receive (e.g., by query, download, and other periodic and ad hoc means) data from a plurality of data sources 102 that have been pre-processed by data pre-processing module 108 and stored in storage 120. Data sources 102 may comprise third-party systems, public (e.g., open source, open dataset) or private (e.g., proprietary). Different data sources 102 may provide different data types, or the same type of data in different formats (e.g., according to different standards). In some examples, data sources 102 may comprise database(s) of electronic health records (EHR) or an enterprise data warehouse (EDW) containing patient health information, a national or international third party database, a specialty registry containing specialized and/or aggregate health data (e.g., clinical data registry), a database of randomized controlled trials (RCT) evidence, and the like. Such existing data may come in the form of various known coding hierarchies, classifications, and terminology standards (e.g., International Classification of Diseases (ICD), Logical Observation Identifiers Names and Codes (LOINC), Systematic Nomenclature of Medicine (SNOMED), Current Procedural Terminology (CPT)).

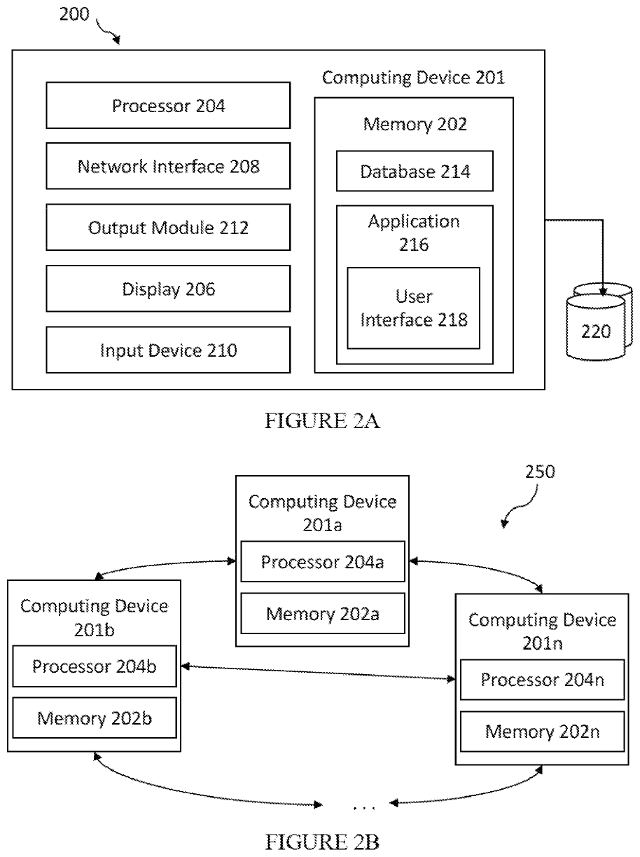

Cohort engine 104 also may be configured to generate patient objects to characterize the medical history of each retrospective patient represented in the received health and medical data. Said patient objects may comprise patient timeline objects representing a patient's medical history over a time period. In some examples, a patient timeline object may encompass a comprehensive timeline of a patient's full medical history. In other examples, the patient timeline object may include a timeline of a part (e.g., available time period) of a patient's medical history. The patient object may be stored in a serialized in-memory byte stream format or on disk storage 120 (or storage 220 in FIG. 2), a database (e.g., database 214 in FIG. 2) and/or an application instance (e.g., application 216 in FIG. 2A). In some examples, a patient object may be compressed and stored in a compressed format in order to optimize in-memory storage space, storage 220, and memory 202. Some examples include a data pre-processing module, a database, and a data abstraction layer to convert unstructured data into a database of structured patient data (e.g., using a data model). In some examples, the database of structured patient data may include patient records structured according to categories, such as demographics, diagnosis codes, measurements, procedures undergone, clinical annotations, and the like.

In certain aspects, the cohort engine 104 is a high performance, distributed, in-memory database engine used to query structured temporal data. The cohort engine 104 can include a compressed memory model optimized to query data features on a patient's timeline, for example. The cohort engine 104 provides clustering capabilities such as, but not limited to clustering capabilities for parallel processing, dynamic schema configuration to allow users to model and populate custom data features, entity linking to preserve relational information from an underlying data source, an updated command syntax to allow for more complex query construction, and the ability to extend the query engine with external custom functions that can be invoked at run-time to support calculated clinical scores.

Interpreter 106 may be configured to apply a selected knowledge graph to structured and unstructured data received from cohort engine 104 (e.g., patient timeline objects). The selected knowledge graph may include an existing knowledge graph, such as, but not limited to a Unified Medical Language System (UMLS), a modified version thereof, or a unique custom knowledge graph created for the system. The selected knowledge graph may include mappings of existing hierarchies and standards to a single standard code, mapping a desired coding standard to other existing hierarchies (e.g., all codes for metformin from the various hierarchies are mapped to a desired tree structure indicating it to be an anti-diabetic drug; all codes for hemoglobin A1c tests from the various hierarchies are mapped to the desired tree structure indicating it is a diabetes test; select codes (e.g., E-08 to E-13) from the various hierarchies are mapped to a given condition or phenotype (e.g., diabetes), even if the an existing hierarchy does not or maps a different range of codes to said condition or phenotype). This application of the selected knowledge graph to all patient data from cohort engine 104, as populated from data sources 102, renders the data easier to use downstream by study templates 110 and analytics engine 112. In so doing, interpreter 106 may automatically validate patient objects and other incoming data from cohort engine 104, so that even if consult request includes a patient profile expressed in a particular classification hierarchy, data that was received across all available hierarchies (e.g., as provided by data sources 102) may be analyzed to provide a response to a consult request, rather than analyzing only the patient data provided in the same classification hierarchy as the consult request.

In an example, a given hierarchy may include codes E-08 to E-13 as relating to a diabetes condition, while another hierarchy includes codes 250 as relating to a diabetes condition. In one example, interpreter 106 may be configured to enforce (i.e., apply) the given hierarchy, such that all codes E-08 to E-13 are related to a diabetes phenotype, regardless of the source (e.g., whether or not the patient data was provided by a source in the given hierarchy or another hierarchy). In another example, interpreter 106 may be configured to enforce a third or other uniquely defined hierarchy (e.g., where E-06 to E-10 is related diabetes).

In certain aspects, the interpreter 106 is a specialized extraction, transformation, and loading (ETL) engine optimized for temporal databases. The interpreter 106 allows users to define the structure of an underlying temporal structure including data features, relationships, and timelines. In addition, users can configure operations to query and load data from external sources into a temporal structure for query. The ETL mechanism provides the ability to split loaded temporal data into multiple shards allowing for the clustering of multiple query engines for horizontal scaling.

Cohort engine 104 may be configured to interpret a consult request query (e.g., as represented in a completed study template, as described herein), sift through available patient data (e.g., patient objects), retrieve appropriate patient data for the consult request query, and push or provide retrieved patient data to analytics engine 112. For example, cohort engine 104 may obtain patient-timeline objects, processed with a selected knowledge graph by interpreter 106, from a memory or storage 120, and provide it to analytics engine 112 in a standard language format (e.g., temporal query language (TQL)). The standard language format may be configured to optimize the patient data for analysis by analytics engine 112. Such configuration may comprise a command or instruction regarding the retrieval of information by cohort engine 104 for analytics engine 112 (e.g., to include or exclude a type of lab result, to include simply a yes or no answer on whether a lab result is available rather than providing the actual lab result value, to include a most recent lab result, to include a patient's entire history of lab results, to include a patient's history of lab results for a given period of time, a given category of tests, and other commands and instructions).

In some examples, cohort engine 104 may use natural language processing (NLP) techniques to manipulate processed data to identify patient data (e.g., patient timeline objects) relevant to a study generated to respond to a consult request (e.g., consult request 114). For example, the study, as may be defined using a study template (e.g., from study templates 110) completed based on consult request 114, may indicate a condition or set of conditions (i.e., phenotype), one or more patient variables or criteria (e.g., age, race, gender, other demographic criteria, treatment(s) and/or procedures undergone), other instructions (e.g., timeframe for study, washout period, outcomes to analyze, other temporal criteria, reporting instructions). In some examples, data pre-processing module 108 also may produce a list of patients (e.g., anonymized or identified) for a study and package the associated patient data for export, for example, to an analytics engine for analysis and reporting. Consult request 114 may be received by electronic mail (“e-mail”), website or web application portal, electronic health records (EHR) system, or other platform or interface.

In some examples, an appropriate study template from study templates 110 may be selected and completed by a user based on information and criteria specified in consult request 114. In other examples, an appropriate study template from study templates 110 may be automatically selected and completed by a system using information in consult request 114. Study templates 110 may comprise a plurality of study templates, each configured to quickly define a study (i.e., a study design or blueprint) and structured to indicate (e.g., for analytics engine 112) how patient data is to be analyzed for the study type corresponding to the study template.

In some examples, the study designs may be retrospective observational studies based on patient outcomes that have already occurred and been recorded, for example, collected observationally (e.g., without active researcher intervention). Such study designs may be descriptive, describing one or more characteristics of a group of individuals, or analytical, to determine relationships (e.g., causal) between exposure/intervention and an outcome. An example of a descriptive study would be to determine the percentage of a group of patients exhibiting a given behavior (e.g., pack a day smokers) that develop a given condition (e.g., lung cancer, heart disease, diabetes, or other illness). An example of an analytical study would be to determine whether a given behavior (e.g., smoking cessation, exercise, diet) reduces the rate by which a group of patients develop a given condition (e.g., lung cancer, heart disease, diabetes, or other illness).

An example of a study template (e.g., one of study templates 110) may be a case series template configured to generate a descriptive study design that describes outcomes for a single group of individuals after an initiating event (e.g., the rate of elevated blood glucose in patients that receive metformin). Another example of a study template may be a sub-group template configured to generate a descriptive study that describes outcomes for a group of individuals after an initiating event that can be subdivided based on characteristics (e.g., the rate of elevated blood glucose in males who receive metformin versus females who receive metformin). Still another example of a study template may be a cohort template configured to generate an analytic study that describes how an intervention and/or exposure is related to an outcome (e.g., does adding glipizide to metformin therapy reduce the rate of elevated blood glucose compared to just metformin). Yet another example of a study template may be a case-control template configured to generate a study that compares patients that develop an outcome to similar patients that develop an outcome, looking back at their histories to determine how different exposures are associated with the outcomes (e.g., what is the association of being prescribed metformin for diabetics that develop kidney failure compared to diabetics that do not develop kidney failure).

Each study template may comprise one or more scripts for implementing an algorithm for performing an associated study type, which may include instructions for querying a database or other storage for cohort data, as defined by fields in the study template. In some examples, the one or more scripts may reference or cross-reference parts or all of other associated studies (e.g., a related study type, previously conducted study).

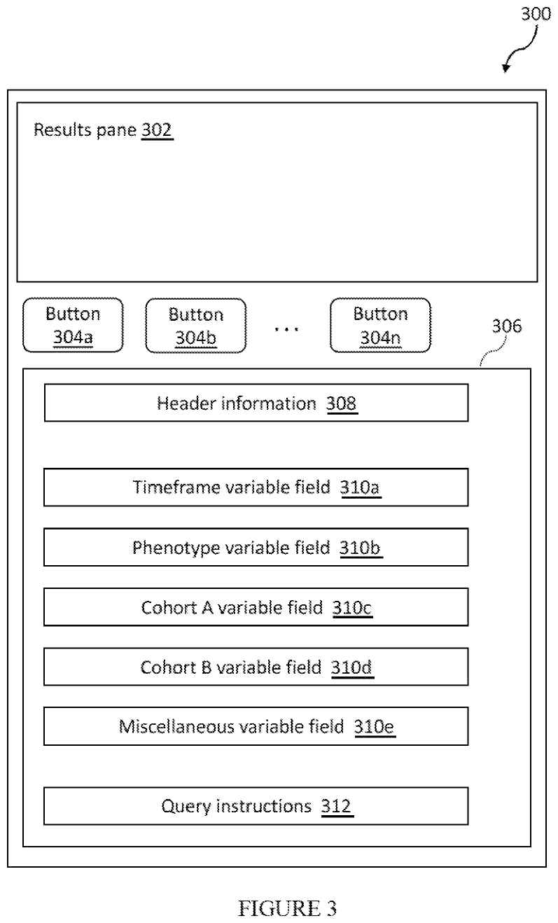

FIG. 3 is a simplified block diagram of an exemplary user interface for completing a study template for input to an analytics engine in a rapid informatics-based prognosis development system, in accordance with one or more embodiments. In some examples, interface 300 may include a results pane 302, which may be at the top of interface 300, as shown, or elsewhere (e.g., middle, bottom, in between buttons 304a-n and window 306, as a pop-up or other window, or other placement). Results pane 302 may be configured to show (e.g., preview) some or all of the results of a study defined by variables input into variable fields 310a-e in window 306. In some examples, the results shown in results pane 302 may include (e.g., display) relevant information (e.g., number of patients returned, number of patients considered (e.g., surveyed, encountered, queried), study type, template type, original data sources, geographical scope), a chart (e.g., various types of graphs, matrices, data sheets, and the like), a label (e.g., gender, race, age range), a value (e.g., a number associated with a point, bar, level, quadrant, row, column, field, or other feature, of a chart), as well as other information relevant to the results.

Each of buttons 304a-n may be configured to implement a function or operation (e.g., run a query based on the criteria specified in window 306 to present results in results pane 302, explore study types or other aspects of study templates, navigate to a different page within interface 300). In some examples, the same buttons 304a-n may persist across all pages in interface 300. In other examples, buttons 304a-n may change (e.g., in order, appearance, type, function) from page to page within interface 300.

In some examples, a window 306 may include header information 308, indicating information associated with the study template (e.g., version, study type, number and type of cohorts, number and type of outcomes, instructions for completion of fields, identification of and/or link to related studies). In some examples, a timeframe variable field 310a may be provided in window 306 for inputting one or more timeframes (e.g., a range of years, range of months, a range from a first date to a second date, including a minimum and a maximum, earliest and latest or present) relevant to the study (e.g., years of patient data, of conditions diagnosed, of treatments undergone, age ranges, intersection of two or more timeframes). In some examples, phenotype variable field 310b may be provided in window 306 for inputting one or more phenotypes or conditions (e.g., diabetes type, cancer type, and other diseases and disease types). In some examples, cohort A and B variable fields 310c-d may be provided in window 306 for inputting variables related to defining a cohort. In an example, cohort A variable field 310c may provide fields for defining a treated cohort (e.g., prescribed medication(s), washout period, treatment(s) and/or procedure(s) provided or performed). In another example, cohort B variable field 310d may provide fields for defining a control cohort (e.g., different prescribed medication(s), no medications during given time period, new users of prescribed medication(s) in a given time period). In some examples, miscellaneous variable field(s) 310e may provide fields for defining other criteria for the study (e.g., demographic criteria, other patient history criteria—medical or otherwise, other eligibility criteria, additional time constraints). Demographic criteria may include, without limitation, age (e.g., actual, range, developmental phase), gender, height, weight, race, hair color, eye color. Other patient history criteria may include frequency of a given behavior (e.g., drinking alcohol, smoking or otherwise ingesting a drug), diagnosed psychological condition, other mental health symptom, related or other medical condition. In some examples, query instructions 312 also may be provided (e.g., instructions for indexing, aggregating, or otherwise organizing or preparing patient data for analysis). In other examples, additional fields may be provided in window 306 or elsewhere in interface 300, on the same or another page (e.g., accessible using one of buttons 304a-n), to complete a study template and generate a study. In some examples, interface 300 may be implemented in the same or similar manner to user interface 218 in FIG. 2.

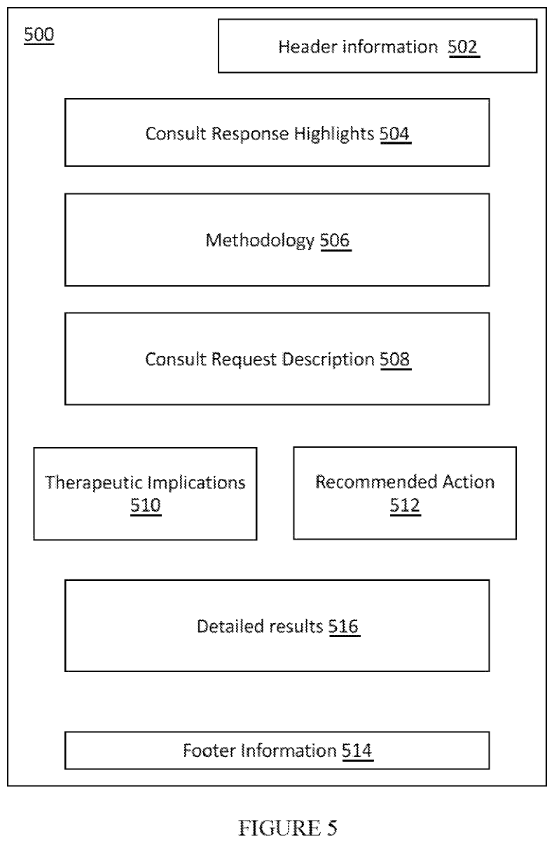

Returning to FIG. 1, analytics engine 112 may be configured to analyze packaged data exported from data pre-processing module 108 according to the criteria and instructions in a completed study template (of study templates 110) to generate a study result. In some examples, analytics engine 112 may be configured to generate a consult output 116 (e.g., a study report) providing actual and/or highlights of results of the study, as defined in a completed study template (e.g., one of study templates 110, as may be completed using interface 300 in FIG. 3). In some examples, consult output 116 may be in the form of report 500 in FIG. 5.

Storage 120 may be implemented in the same or similar manner to storage 220 in FIG. 2, as described below. Storage 120 may be configured to store phenotypes (e.g., in SQL, TQL, or other desired language). In an example, edits to phenotypes may be stored in storage 120 with a title (e.g., a name or tag) for ease of classification and categorization (e.g., by interpreter 106), retrieval of patient data (e.g., by data pre-processing 108), and identification (e.g., in a study template or interface for completing a study template). For example, such phenotype titles may be selectable by menu (e.g., drop down) or auto-complete (e.g., when a user begins to enter a word or part of a word, all phenotypes relating to the word may be suggested) in an interface (e.g., interface 300). Storage 120 also may be configured to store patient data, both unstructured and structured (e.g., as patient timeline objects), a desired or selected query language, one or more study templates 110, reports and other output from analytics engine 112, as well as other data and instructions related to system 100.

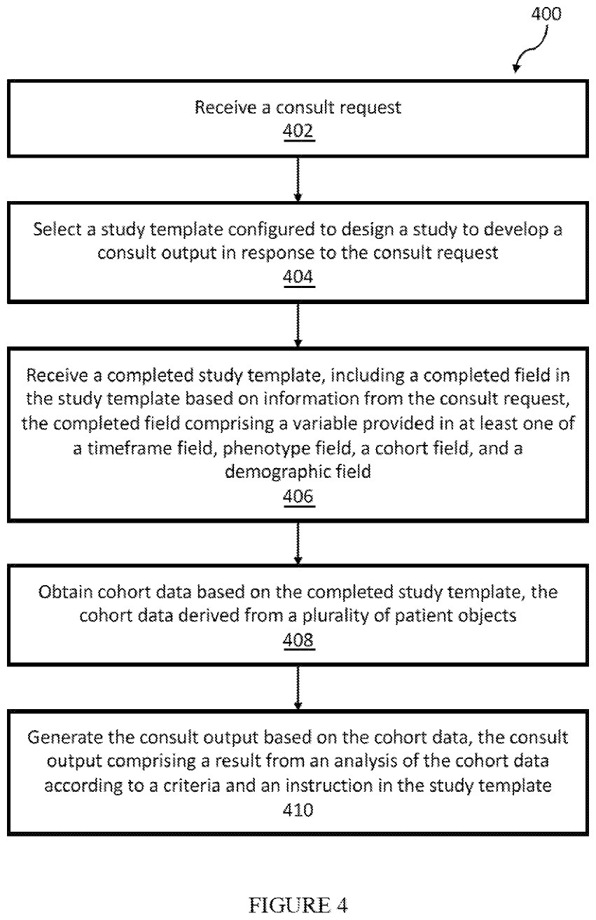

FIG. 2A is a simplified block diagram of an exemplary computing system configured to implement the exemplary system in FIG. 1 and to perform steps of the method illustrated in FIG. 4, in accordance with one or more embodiments. In one embodiment, computing system 200 may include computing device 201 and storage system 220. Storage system 220 may comprise a plurality of repositories and/or other forms of data storage, and it also may be in communication with computing device 201. In another embodiment, storage system 220, which may comprise a plurality of repositories, may be housed in one or more of computing device 201. In some examples, storage system 220 may store patient data (e.g., structured and unstructured), query languages, study templates, reports, instructions, programs, and other various types of information as described herein. This information may be retrieved or otherwise accessed by one or more computing devices, such as computing device 201, in order to perform some or all of the features described herein. Storage system 220 may comprise any type of computer storage, such as a hard drive, memory card, ROM, RAM, DVD, CD-ROM, write- capable, and read-only memories. In addition, storage system 220 may include a distributed storage system where data is stored on a plurality of different storage devices, which may be physically located at the same or different geographic locations (e.g., in a distributed computing system such as system 250 in FIG. 2B). Storage system 220 may be networked to computing device 201 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 201 also may include a memory 202. Memory 202 may comprise in-memory storage configured to store a database 214 and an application 216. Application 216 may include instructions which, when executed by a processor 204, cause computing device 201 to perform various steps and/or functions (e.g., analyzing patient data, performing a cohort-based study, generating a report in response to a consult request), as described herein. Application 216 further includes instructions for generating a user interface 218 (e.g., graphical user interface (GUI)). Database 214 may store various algorithms and/or data, including neural networks and data regarding patients, medical histories, study templates, cohorts, among other types of data. Memory 202 may include any non-transitory computer-readable storage medium for storing data and/or software that is executable by processor 204, and/or any other medium which may be used to store information that may be accessed by processor 204 to control the operation of computing device 201.

Computing device 201 may further include a display 206, a network interface 208, an input device 210, and/or an output module 212. Display 206 may be any display device by means of which computing device 201 may output and/or display data. Network interface 208 may be configured to connect to a network using any of the wired and wireless short range communication protocols described above, as well as a cellular data network, a satellite network, free space optical network and/or the Internet. Input device 210 may be a mouse, keyboard, touch screen, voice interface, and/or any or other hand-held controller or device or interface by means of which a user may interact with computing device 201. Output module 212 may be a bus, port, and/or other interfaces by means of which computing device 201 may connect to and/or output data to other devices and/or peripherals.

In one embodiment, computing device 201 is a data center or other control facility (e.g., configured to run a distributed computing system as described herein), and may communicate with one or more health data systems (e.g., data sources 102 and/or cohort engine 104 in FIG. 1). As described herein, system 200, and particularly computing device 201, may be used for automatically and/or quickly defining and performing health and medical studies (e.g., retrospective observational studies), running a cohort engine and interpreter application(s), pre-processing and analyzing patient data, and otherwise implementing steps in a rapid informatics-based prognosis and treatment development system, as described herein. Various configurations of system 200 are envisioned, and various steps and/or functions of the processes described below may be shared among the various devices of system 200 or may be assigned to specific devices.

FIG. 2B is a simplified block diagram of an exemplary distributed computing system implemented by a plurality of exemplary computing devices, in accordance with one or more embodiments. System 250 may comprise two or more computing devices 201a-n. In some examples, each of 201a-n may comprise one or more of processors 204a-n, respectively, and one or more of memory 202a-n, respectively. Processors 204a-n may function similarly to processor 204 in FIG. 2A, as described above. Memory 202a-n may function similarly to memory 202 in FIG. 2A, as described above.

FIG. 4 is a flow diagram illustrating an exemplary method for rapid informatics-based prognosis development, in accordance with one or more embodiments. Method 400 may begin with receiving a consult request at step 402. Said consult request may be received by email, website or web application portal, EHR system, or other platform or interface. A study template may be selected at step 404, the study template configured to design a study to develop a consult output in response to the consult request. As described herein the study template may be configured to design one or both of a descriptive study and an analytical study. A study template may comprise at least one of a case series template, a sub-group template, a cohort template, and a case-control template, among others. A completed study template may be received at step 406, the completed study template including a completed field in the study template based on information from the consult request, the completed field comprising a variable provided in at least one of a timeframe field, a phenotype field, a cohort field, and a demographic field. In some examples, each of these fields may comprise one or more fields for input by a user or for automatic input by the system based on information provided in the consult request.

Cohort data may be obtained based on the completed study template at step 408, the cohort data derived from a plurality of patient objects. In some examples, cohort data may include patient objects that form a cohort according to defined criteria for the cohort (e.g., defining a given age range, a given phenotype, a given time period). In some examples cohort data may include patient objects that form two or more cohorts, wherein a first cohort is being compared with a second cohort in the study (e.g., a particular therapeutic cohort compared with a control cohort; two different therapeutic cohorts being compared with each other). In other examples, more than two cohorts may be included in a study. In some examples, each of the plurality of patient objects may comprise a patient timeline object configured to provide a patient medical history over a time period. In some examples, the patient timeline object may encompass a comprehensive timeline of a patient's full medical history. In other examples, the patient timeline object may include a timeline of a part (e.g., available time period) of a patient's medical history. The patient object may be stored in a serialized in-memory byte stream format. In some examples, the patient timeline object may be stored in a database and/or an application instance.

In some examples, obtaining the cohort data includes selecting, by a data pre- processing module (e.g., data pre-processing module 108 in FIG. 1) patient objects (e.g., patient timeline objects) generated by a cohort engine (e.g., cohort engine 104 in FIG. 1) and modified by an interpreter (e.g., interpreter 106 in FIG. 1), using criteria and instructions provided by the completed study template. As described herein, a cohort engine may have ingested patient data from a plurality of sources in a plurality of formats (e.g., according to various classification and coding hierarchies), and converted the patient data into a patient object for each patient represented in the patient data. An interpreter may have conformed the patient object(s) to a previously selected hierarchy, applying a selected knowledge graph to the patient object(s) for ease of selection and analysis downstream.

The consult output may be generated based on the cohort data at step 410, the consult output comprising a result from an analysis of the cohort data according to a criteria and an instruction in the completed study template. The consult output may be in the form of a report (e.g., report 500 in FIG. 5). In some examples, an optional step may include determining whether the consult request is suitable for analysis by the system. In some examples, the consult output may be provided a user or system from which the consult request was received. In some examples, the study may be completed, the consult output generated and provided, within (i.e., less than) 24 hours or within 48 hours of receiving the consult request. In other examples, the process may take up to a few days, a week, several weeks or months (e.g., depending on complexity of the consult request, amount of patient data to analyze, compute power, and other factors). In some examples, the consult request is for the purpose of obtaining a second, evidence-based opinion on a patient case.

FIG. 5 is a simplified block diagram of exemplary elements of a report generated by a rapid informatics-based prognosis development system, in accordance with one or more embodiments. Report 500 may include several sections (e.g., features), such as header information 502, consult response highlights 504, methodology 506, consult request description 508, therapeutic implications 510, recommended action 512, and footer information 514. In some examples, header information 502 may include patient identifying information (e.g., a name, a unique identifier (e.g., member number, randomly generated identifier, anonymous identifier, social security number, telephone number, or other identifier)), request date, and requester information (e.g., health provider, doctor or other authorized medical professional, researcher, system), among other report characteristics. In some examples, consult response highlights 504 may include highlights of results from an analysis performed according to a study (e.g., a retrospective observational study, as described herein), including data highlights from relevant cohort data in the form of visuals (e.g., charts, graphs, infographics, word clouds, diagrams, scans, x-rays, clusters, heat maps, matrices, dashboard, evidence board) or text (e.g., lists, summaries, blurbs, other descriptions). In some examples, consult response highlights 504 may present data that is aggregated, while in other examples, consult response highlights 504 may present patient specific data. In either circumstance, the presentation may be anonymized. In some examples, consult response highlights also may include a list or description of features of the study, such as a total number of patient records compared, a number of similar patients found, a number of control patients, a brief conclusion or answer, and the like.

Methodology 506 may provide a description or features of the study performed in list, narrative, chart, or other form. For example, methodology 506 may indicate a population surveyed in the study (e.g., demographic, phenotype, and other population-related criteria), an intervention (e.g., treatment prescribed and administered, procedures undergone), any control criteria, outcome criteria, timeframe criteria, and other criteria used in the study. In some examples, methodology 506 may include a standard set of information across all reports or reports of a given type. In other examples, methodology 506 may include a customized set of information. In some examples, methodology 506 may include information from a completed study template (e.g., one of study templates 110 in FIG. 1, as may be completed using window 306 in interface 300 in FIG. 3).

Consult request description 508 may include a query description of the request for which the study defined in methodology 506 was performed in response. Consult request description 508 may include a general question, patient specific question, group specific question, or other type of question. Therapeutic implications 510 may indicate a conclusion or recommendation regarding a therapy and/or a course of treatment based on results of the study. Recommended action 512 may indicate recommended actions for the subject patient of the consult request (e.g., a change in dose, continuation, escalation, or cessation of a treatment).

Footer information 514 may include various information related to the analysis being provided, including, but not limited to, a doctor involved with the study (e.g., initiating, defining, validating the results of, double checking, the study), a date, a page number, a name and logo of a company providing the report and/or performing the analysis. In some examples, detailed results 516 also may be provided, on the same or a separate page, in various formats and level of detail.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A method for rapid informatics-based prognosis development, the method comprising:
receiving a consult request;
selecting a study template configured to design a study to develop a consult output in response to the consult request;
receiving a completed study template, including a completed field in the study template based on information from the consult request, the completed field comprising a variable provided in at least one of a timeframe field, a phenotype field, a cohort field, and a demographic field;
obtaining cohort data based on the completed study template, the cohort data derived from a plurality of patient objects; and
generating the consult output based on the cohort data, the consult output comprising a result from an analysis of the cohort data according to a criteria and an instruction in the study template.

2. The method of claim 1, wherein the study comprises one or both of a descriptive study and an analytical study.

3. The method of claim 1, wherein the study template comprises one or more of a case series template, a sub-group template, a cohort template, and a case-control template.

4. The method of claim 1, wherein the consult output is generated within 24 hours of receiving the consult request.

5. The method of claim 1, wherein the consult output is generated within 48 hours of receiving the consult request.

6. The method of claim 1, wherein the consult output is generated within 1 week of receiving the consult request. 7 A system for rapid informatics-based prognosis development, the system comprising:
a memory comprising instructions; and
a processor configured to execute the instructions which, when executed, cause the processor to:
receive a consult request;
select a study template configured to design a study to develop a consult output in response to the consult request;
receive a completed study template, including a completed field in the study template based on information from the consult request, the completed field comprising a variable provided in at least one of a timeframe field, a phenotype field, a cohort field, and a demographic field;
obtain cohort data based on the completed study template, the cohort data derived from a plurality of patient objects; and
generate the consult output based on the cohort data, the consult output comprising a result from an analysis of the cohort data according to a criteria and an instruction in the study template.

8. The system of claim 7, wherein the study comprises one or both of a descriptive study and an analytical study.

9. The system of claim 7, wherein the study template comprises one or more of a case series template, a sub-group template, a cohort template, and a case-control template.

10. The system of claim 7, wherein the consult output is generated within 24 hours of receiving the consult request.

11. The system of claim 7, wherein the consult output is generated within 48 hours of receiving the consult request.

12. The system of claim 7, wherein the consult output is generated within 1 week of receiving the consult request.

13. A non-transitory machine-readable storage medium comprising machine-readable instructions for causing a processor to execute a method for rapid informatics-based prognosis development, the method comprising:
receiving a consult request;
selecting a study template configured to design a study to develop a consult output in response to the consult request;
receiving a completed study template, including a completed field in the study template based on information from the consult request, the completed field comprising a variable provided in at least one of a timeframe field, a phenotype field, a cohort field, and a demographic field;
obtaining cohort data based on the completed study template, the cohort data derived from a plurality of patient objects; and
generating the consult output based on the cohort data, the consult output comprising a result from an analysis of the cohort data according to a criteria and an instruction in the study template.

14. The non-transitory machine-readable storage medium of claim 13, wherein the study comprises one or both of a descriptive study and an analytical study.

15. The non-transitory machine-readable storage medium of claim 13, wherein the study template comprises one or more of a case series template, a sub-group template, a cohort template, and a case-control template.

16. The non-transitory machine-readable storage medium of claim 13, wherein the consult output is generated within 24 hours of receiving the consult request.

17. The non-transitory machine-readable storage medium of claim 13, wherein the consult output is generated within 48 hours of receiving the consult request.

18. The non-transitory machine-readable storage medium of claim 13, wherein the consult output is generated within 1 week of receiving the consult request.
